(19) United States
(12) Patent Application Publication
(10) Pub. No.: US 2012/0066155 A1
(43) Pub. Date: Mar. 15, 2012

(54) System and Method For Providing Hearing Services

(76) Inventors: Reginald Garratt, Naples, FL (US); Lynn Charlier, Ft. Meyer, FL (US)

(21) Appl. No.: 12/880,855

(22) Filed: Sep. 13, 2010

(51) Int. Cl. G06Q 90/00

(52) U.S. Cl. 705/500

(57) ABSTRACT

A contract fee is obtained from the one or more licensed medical professionals who may lease all or part of a hearing center. The lease fee is applied exclusively to expenses associated with a hearing center and the hearing center utilizes an Audiologist or Hearing Instrument Specialist. The patient is screened by the one or more licensed medical professionals according to one or more first screening methods. When the first screening indicates a potential hearing problem with the patient, the patient is referred to the hearing center. The patient undergoes an audiometric exam by the Audiologist or Hearing Instrument Specialist for hearing loss at the hearing center. When the testing by the Audiologist or Hearing Instrument Specialist indicates a need for a hearing instrument, a hearing instrument is ordered from the hearing instrument supplier. The hearing aid is fitted to the patient by the Audiologist or Hearing Instrument Specialist onsite at the hearing center. The profit to participating medical professionals is determined by the number of referrals that practitioner generates and sends to the Hearing Center that also result in sales of hearing instruments.

### BACKGROUND

The prevalence of hearing loss is a growing concern for many in society today. Hearing loss may result in as well as magnify the severity of a variety of physical and psychological problems. It is an unfortunate fact that many patients suffering from hearing loss are never diagnosed, let alone treated for their condition as indicated in a NCOA study.

Various types of hearing instrument services are provided today. Licensed Audiologists and Hearing Instrument Specialists are required to fit the hearing aids with the patient in many if not most jurisdictions. Based upon a variety of audiometric tests, the Audiologist or Hearing Instrument Specialist orders a digital hearing instrument, which the Audiologist or Hearing Instrument Specialist adjusts to meet the specific needs of the patient. Thus, in some way, the patient must locate an Audiologist or Hearing Instrument Specialist to obtain treatment.

Sensorineural hearing loss is the most prevalent type of hearing loss and is only treatable with the amplification of sound through the use of hearing instruments. The vast majority (or 90%) of hearing impaired people know that they have an impairment and choose to do nothing about it until their mental health deteriorates as indicated in a NCOA study.

While simple in theory, this approach of supplying hearing aids to patients suffers from several shortcomings. In particular, the patient may be reluctant to schedule an appointment with an audiologist since an audiologist may be difficult to find or the patient may not have a particular comfort level with audiologists in general. Thus, the patient who is suffering from potential hearing loss may go without proper treatment.

A general practitioner, or other “gatekeeper” is typically the initial (and sometime only) contact a patient has with medical professionals and the general practitioner may potentially screen the patient for hearing problems. In practice, however, this rarely occurs since the general practitioner has no financial or other incentive to perform the hearing screening, nor does the practitioner have any financial or other incentive to refer patients to an Audiologist or Hearing Instrument Specialist to receive audiometric testing. In particular, physicians and other medical professionals are prohibited by law and/or ethical rules from receiving financial compensation when referring patients to another medical professional (e.g., an audiologist). Audiologists may be directly employed by physicians, but this is expensive and time consuming to implement. As a result, many patients that have hearing problems pass through the medical system without receiving any form of hearing loss treatment.

### BRIEF DESCRIPTION OF THE DRAWINGS

FIG. 1 is a block diagram illustrating a system for supplying hearing instruments to patients according to various embodiments of the present invention;

FIG. 2 is a flowchart of an approach for providing hearing instruments to patients according to various embodiments of the present invention;

FIG. 3 is a block diagram of a hearing center according to various embodiments of the present invention;

FIG. 4 is a block diagram showing at least one software module executed on a hardware platform that are used to screen patients and provide business services according to various embodiments of the present invention; and

FIG. 5 is a block diagram showing one example of an approach for determining profits according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

Approaches are provided for distributing hearing instruments to patients, enabling a General Practitioner (GP) or other medical doctor (or any other party who can legally screen patients for potential hearing impairment), to refer the patient or person to a licensed Audiologist or Hearing Instrument Specialist at a hearing center for an audiometric test and for the GP to be compensated for any referral which results in the sale of hearing instruments to the referred patient. Through this approach, profits are created as a result of the increase in the number of patients being identified with hearing loss as well as an increase in the number of referrals to the appropriate Hearing Healthcare Professionals for diagnosis and if necessary, appropriate treatment.

In many of these embodiments, one or more licensed medical professionals that can provide initial hearing screening services are identified. When the one or more licensed medical professional are identified, a monetary contribution is obtained from each of the licensed medical professionals. That contribution is then applied exclusively to expenses associated with the hearing center and the hearing aid center utilizes a licensed Audiologist or Hearing Instrument Specialist. The patient is screened initially by the one or more licensed medical professional according to one or more first tests.

When the first hearing screening indicates a potential hearing problem with the patient, the patient is referred to the hearing center by the licensed medical professional that performed the screening. At the hearing center, the patient then receives an audiometric exam from the Audiologist or Hearing Instrument Specialist on staff at the hearing center. When the testing by the Audiologist or Hearing Instrument Specialist indicates a need for a hearing instrument, a hearing instrument (e.g., hearing aid) is ordered from a hearing instrument provider. The hearing instrument is fitted and adjusted to the auditory response of the patient by the Audiologist or Hearing Instrument Center on site at the hearing center.

In other aspects, the licensed medical professional may be a general practitioner, an ophthalmologist or any “gatekeeper”. The screening process may utilize a hearing questionnaire or a hand held screening device. Other examples and types of tests are possible. In another aspect, the medical professionals are the exclusive leaseholders of the hearing center.

As used herein a “Gatekeeper” is any medical or other professional who regularly treats patients, especially those that are 50 years and older. A “Sensorineural Loss” is a hearing impairment caused by the deterioration of cochlear nerve cells due to aging. A “Leaseholder” is a medical or other professional who leases all or part of a Hearing Center. A “screening” is a method of testing the auditory response of a patient to acoustic signals.

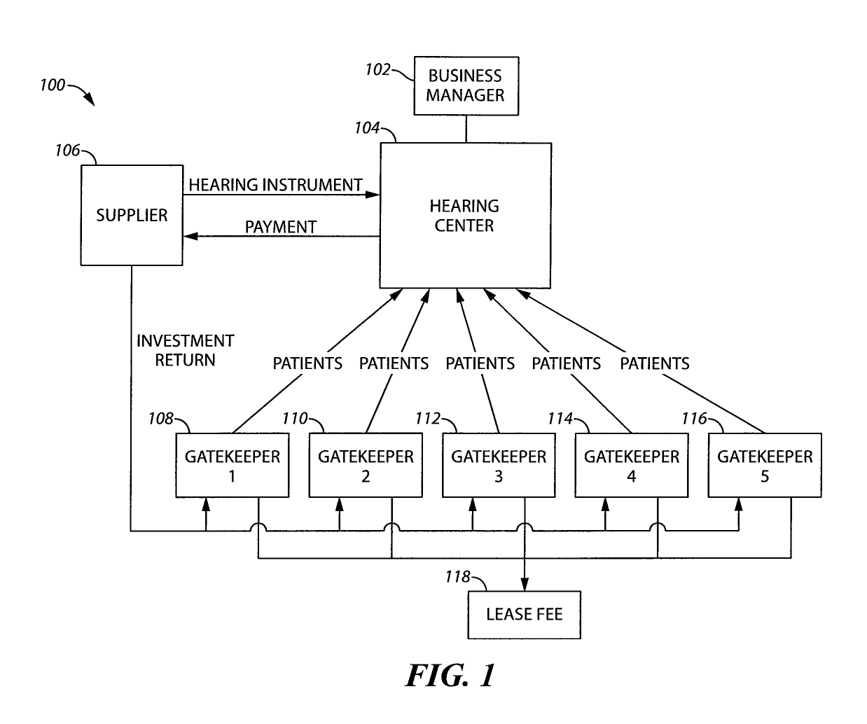

Referring now to FIG. 1, one example of a system 100 for providing hearing services to patients is described. The system 100 includes a hearing center 104, a business manager 102, a hearing instrument supplier 106, gatekeepers 108, 110, 112, 114, and 116 and a hearing center investment 118.

The hearing center 104 is a physical space that has a licensed audiology professional (e.g., a licensed audiologist) employed to conduct hearing tests on patients. As described elsewhere herein, a variety of tests can be performed. The center 104 (via the audiologist or others) also orders and receives hearing instruments (e.g., hearing aids) that are sold and fitted to the patient. The hearing center 104 may also deploy business management approaches (e.g., implemented as computer software executed on computer hardware platforms) that electronically receive referral and patient scheduling information and determine profits for the owners of the hearing center 104 (i.e., the licensed medical professionals).

In other aspects, the physical space occupied by the hearing center may be leased (e.g., by the leaseholders). Additionally, a company may be incorporated or otherwise organized as an other legal business entity according to the laws of any jurisdiction (e.g., the jurisdiction where it is located) and this company or other organization owns the hearing center. In other aspects, the company owning the hearing center 104 may own multiple centers or only one center. The company owning the center 104 may sell the hearing instrument to the patient. The hearing center 104 may obtain the hearing instrument from any supplier or chain of suppliers.

As mentioned, the hearing center 104 is manned by a certified audiologist or State certified HIS (Hearing Instrument Specialist). The hearing center 104 equipped with audiometric equipment necessary to measure the hearing parameters of a patient, plus other ancillary furniture, and any other needed items.

The business manager 102 may be a dedicated person and/or computer hardware/software that manages business services at the hearing center 104. In the respect, and as mentioned, referral information, patient scheduling, hearing instrument ordering, and profit calculation may be performed by the business manager 106.

The hearing instrument supplier 106 supplies hearing instruments (e.g., hearing aids or any other instrument inserted in or around the ear). The hearing instrument supplier 106 receives payment from the hearing center 104, in one example, electronically using the credit cards of the gatekeepers 108, 110, 112, 114, and 116. Other payment mechanisms may also be used.

The gatekeepers 108, 110, 112, 114, and 116 are individuals and/or organizations that refer patients to the hearing center 104. In one example, the gatekeepers 108, 110, 112, 114, and 116 are general practitioner (GP) medical doctors. The gatekeepers 108, 110, 112, 114, and 116 typically perform an initial screening for the patients and if a potential hearing problem is identified, the patients are referred to the hearing center 104 where further testing and the actual fitting of the hearing instrument by a licensed audiologist is accomplished.

The hearing center lease fee 118 is a monetary amount supplied by the gatekeepers 108, 110, 112, 114, and 116 for lease payment is to solely operate the hearing center 104. In one example, this is the total and complete revenue for the hearing center 104 (i.e., there are no other investments or investors other than those lease payments made by the gatekeepers 108, 110, 112, 114, and 116). Each owner is considered a member of the company owning the hearing center 104 and each member is responsible for making their payment by a required time (e.g., every quarter or every month).

The appointed Audiologist or Hearing Instrument Specialist places orders for the hearing instruments (HI) from a supplier or through the hearing center itself (i.e., the hearing center's owner HI's). As mentioned, payment for the hearing instrument may be accomplished using credit cards with the credit cards supplied by each medical doctor or some combination.

A net profit per gatekeeper (e.g., doctor) member is determined after the cost of hearing instrument to the hearing center, commission to dispenser, commission to investment manager and overhead expense has been deducted from the hearing instrument unit's retail sale price. All net profits are distributed in direct proportion to the HI sold to the relevant doctor.

The profit from the purchase price of the HI from a manufacturer (or supplier) less the cost of the HI to the hearing center 104 results in a gross profit on each HI sale. This profit less expenses may be paid into an escrow fund and after a predetermined time period, may be distributed to others (e.g., other investors or managers) who may manage the operation of hearing centers. It will be appreciated that other profit determinations may be used that utilize the same or other factors.

Various medical professionals can be recruited to participate in the above described system. For example, ophthalmologists, general practitioners or medical doctors of other areas of medical practice can be recruited. As mentioned, a “gatekeeper” means a licensed medical doctor (or other medical professional) that sees these patients on a regular basis.

The owner of the hearing center 104 (e.g., a company) may arrange for the audiometric test equipment and its own sources of hearing aids to supply to patients. The company may arrange for a supply of various digital hearing instruments to patients.

In some aspects, every successful recruitment of a predetermined number of members (e.g., per audiologist) triggers the leasing of the medical office, hiring and training of a dispenser and buying equipment office ware and so forth.

The hearing center 104 may offer various other product specials in which medical professionals may participate. In one example, the hearing center may promote a free pair of hearing instruments to each medical doctor or other professional entity who refers patients and purchases a certain number (e.g., ten) hearing instruments as a result of those referrals. That free pair of hearing instruments must then be donated to a qualifying indigent patient and may not be resold for profit. Other examples are possible.

In one example of the operation of the system of FIG. 1, one or more licensed medical professionals that provide initial hearing screening services are identified. When the one or more licensed medical professional are identified, a predetermined contract fee is obtained from the one or more licensed medical professionals. The fee is applied exclusively to operating expenses of the hearing center 104, and the center utilizes the services of an Audiologist or Hearing Instrument Specialist. The patient is screened by the one or more licensed medical professional according to one or more first methods of screening

When the first screening indicates a potential hearing problem with the patient, the patient is then referred to the hearing center 104. The patient is tested by the Audiologist or Hearing Instrument Specialist for hearing loss at the hearing center 104 using one or more second tests. When the testing by the audiologist indicates a need for a hearing instrument, a hearing aid is ordered from a hearing aid provider. The hearing aid is fitted to the patient by the Audiologist or Hearing Instrument Specialist.

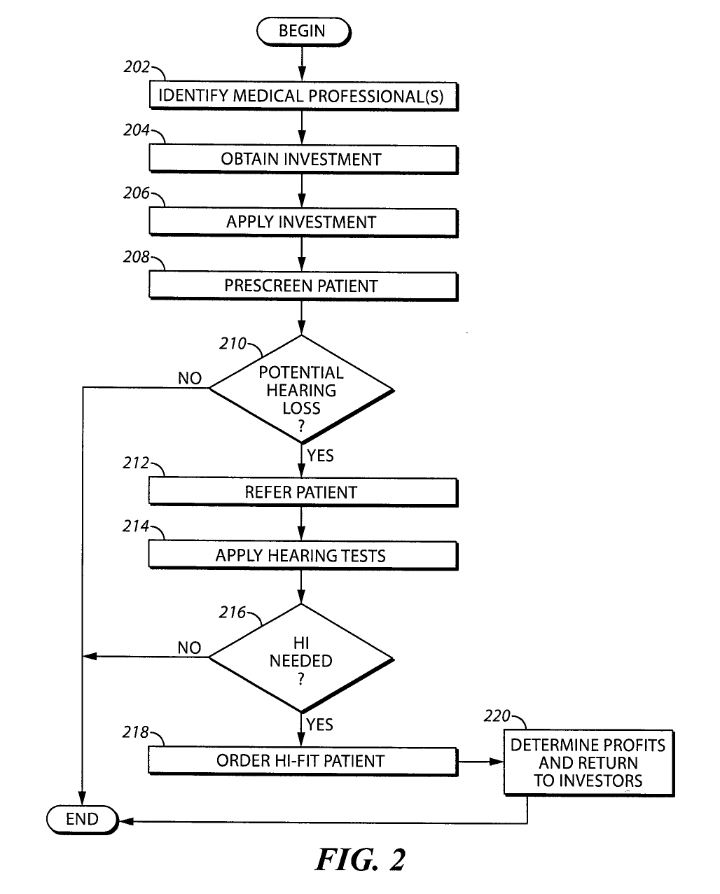

Referring to FIG. 2, one example of an approach for supplying hearing instruments to patients is described. At step 202, medical professionals (i.e., gatekeepers) are identified that can perform initial screening of patients for hearing loss. In one example, the medical professionals are licensed general practitioners or other “gatekeeper”. The practitioners may be targeted based upon their location, the age of the patient population of the surrounding areas or any other factor that is useful in identifying medical professionals that might encounter patients with hearing loss. In one example, the medical professionals may be general practitioners in an area with an older population (e.g., above fifty years in age). In another example, the medical professionals may be ophthalmologists. Other criteria for the targeting of medical professionals is possible.

At step 204, at for a hearing center is obtained from the medical professionals. In one example, this is the exclusive investment for the hearing center (i.e., there will be no other investors).

At step 206, the investment is applied to open and operate the hearing center. The investment may be a single payment or periodic payments that is made over time (e.g., in monthly payments).

At step 208, the medical professional initially screens the patients. The initial testing can be accomplished via a number of different tests.

At step 210, it is determined from the prescreening if the patient may have a hearing loss problem. If the answer is affirmative, execution continues at step 212. If the answer is negative, execution ends.

At step 212, a referral is made to the hearing center. This maybe accomplished by electronically and automatically by scheduling a patient for an appointment at the hearing center.

At step 214, at a hearing center, a detailed screening and hearing analysis is performed. For example, various detailed tests as known to those skilled in the art may be performed.

At step 216, it is determined if the patient needs a hearing instrument. This may be accomplished under the direct supervision and control of the audiologist at the hearing center. If the answer is negative, execution ends and if the answer is affirmative, then execution continues at step 218.

At step 218, the hearing instrument is ordered. The hearing instrument may be paid for using an account of the medical practitioner. An escrow account can also be used.

At step 220, the net profit is calculated. Compensation is then sent to the practitioner. This maybe accomplished electronically or the sending of a check to mention a few examples. The payment may occur across any time period (e.g., monthly, yearly, and so forth).

In one example, the net profit is generated after the hearing aid unit selling price is deducted from the cost, the commission of the dispenser, any investment manager expenses, and any overhead. All net profits are distributed in direct proportion to the investment made.

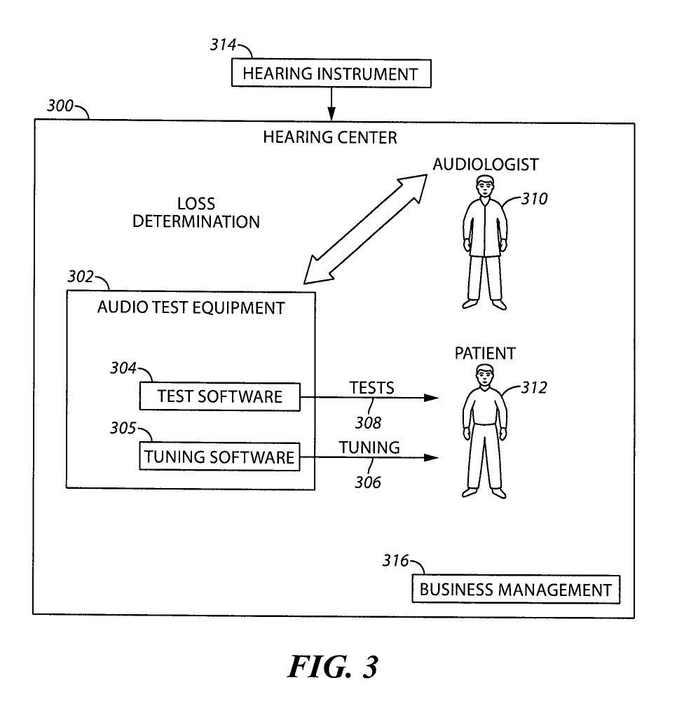

Referring now to FIG. 3, one example a hearing center 300 is described. The hearing center includes hearing test equipment 302 and business management equipment 316. The hearing center 304 deploys at least one audiologist 310 to see a patient 312.

The test equipment 302 may be any combination of computer hardware and/or software that implements testing software 304. The testing software 304 may execute tests 308 with the patient 312. A hearing instrument 314 (e.g., a hearing aid) may be ordered based upon the results of the tests. Once ordered, the audiologist 310 fits the patient 312 with the hearing instrument 314.

The business management equipment 316 may execute a variety of functions. For example, the business management equipment 316 may be a computer hardware/software platform that performs ordering of the hearing instruments 314, payment for the hearing instruments 314, patient scheduling, profit calculations, and profit distribution. Other business related functions may also be performed. The functions can be provided from other locations besides the haring center 300.

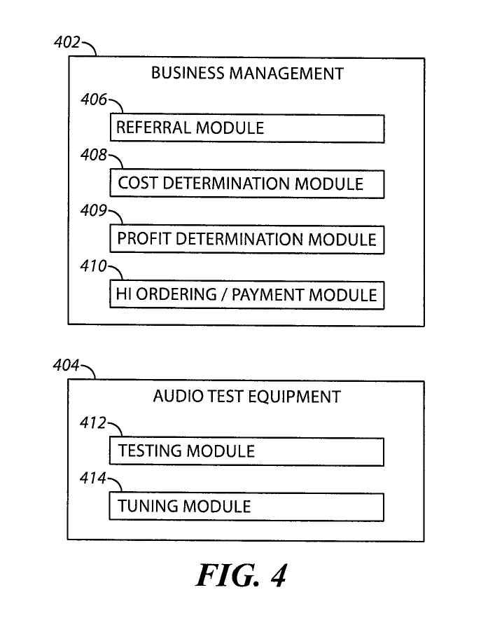

Referring now to FIG. 4, one example of modules for providing patient services is described. A business management module 402 may include a referral module 406, a cost determination module 408, a profit determination module 409, and a hearing instrument ordering and payment module 410. The audio test module 404 includes a testing module 412 and a tuning module 414. It will be appreciated that any and all of these modules may be implemented by any combination of human action and/or computer hardware/software.

The referral module 406 may receive patient referrals from medical professionals and schedule appointments for the patients referred by these referrals. The cost determination module 408 may determine the costs associated with overhead of the hearing center, the hearing instrument, and so forth. These costs may be used in the in the profit determination.

The profit determination module 409 calculates the profits for the owners of the hearing center based upon, for instance, the selling price of the hearing instrument to the patients and costs identified by the cost determination module 408. The hearing instrument ordering and payment module 410 orders hearing instruments from a supplier and pays for these ordered hearing instruments. For example, this may be accomplished using the credit cards of the owners of the hearing center.

The testing module 412 instigates and conducts hearing tests with the patient. The tuning module 414 is used by the audiologist to fine tune the hearing instrument once the patient has been fitted with the hearing instrument. The testing and fine tuning can be accomplished by any technique know to those skilled in the art.

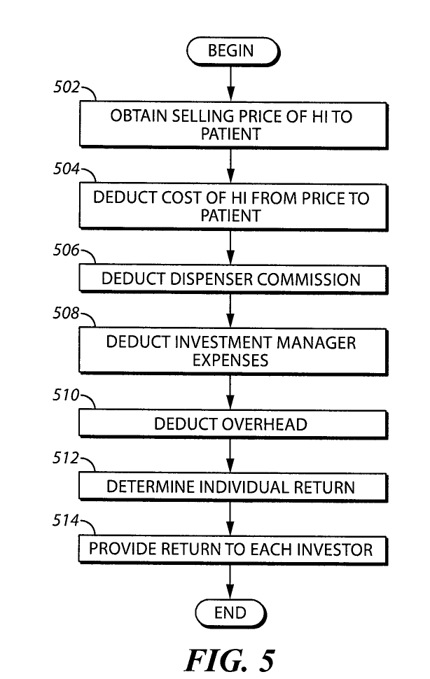

Referring now to FIG. 5, one example of an approach for determining the profits due the owners of a hearing center is described. At step 502, the selling price to the patient of the hearing instrument is obtained. At step 504, the cost of the hearing instrument to the hearing center is deducted from this price. Further, at step 506, a dispenser commission is deducted from the price.

At step 508, investment management fees are deducted from the price. At step 510, overhead expenses (e.g., rental fees, electricity, and so forth) of the hearing center are deducted from the price.

Thus, approaches are provided for distributing hearing instruments, enabling a General Practitioner (GP) or other medical doctor (or any other party who can legally screen patients for potential hearing impairment), to refer the patient or person a licensed Audiologist or Hearing Instrument Specialist an audiometric exam and for the GP (or other party) to be compensated for that referral which results in the sale of hearing instruments to the referred person.

While the invention herein disclosed has been described by means of specific embodiments and applications thereof, numerous modifications and variations could be made thereto by those skilled in the art without departing from the scope of the invention.

What is claimed is:

1. A method of providing hearing services to patients, the method comprising:
identifying one or more licensed medical professionals to provide initial hearing screening services;
when the one or more licensed medical professional are identified, obtaining a contract fee from the one or more licensed medical professionals;
applying the contract fee exclusively to expenses associated with a hearing center, the hearing center utilizing a licensed Audiologist or Hearing Instrument Specialist;
screening the patient by the one or more licensed medical professional according to one or more first screening methods;
when the first screenings indicate a potential hearing problem with the patient, referring the patient to the hearing center;
testing a patient by the licensed Audiologist or Hearing Instrument Specialist for hearing loss at the hearing center through the audiometric exam;
when the testing by the licensed audiology professional indicates a need for a hearing instrument, ordering a hearing aid from a hearing aid provider;
fitting the hearing aid to the patient by the licensed audiology professional at the hearing center.

2. The method of claim 1 wherein the licensed medical professional is selected from the group consisting of a general practitioner and an ophthalmologist.

3. The method of claim 1 wherein the screening comprises uses a questioner.

4. The method of claim 1 wherein the screening is accomplished by using a hand-held screener utilizing frequency-response methods.

5. The method of claim 1 wherein the medical professionals are the exclusive investors.

6. A hearing center comprising:
means for receiving a referral from a licensed medical professional, the referral associated with a patient having suspected hearing loss;
hearing testing equipment that is controlled and operated by a licensed audiologist and that is used to test the patient to certainly determine the existence of hearing loss in the patient;
means for ordering a hearing instrument when the testing equipment determines that a hearing loss exists in the patient;
means for compensating the licensed medical professional for the referral of the patient.

7. The hearing center of claim 6 wherein the means for compensating determines a profit based at least in part upon the cost of the hearing instrument.
